(19) United States
(12) Patent Application Publication
(10) Pub. No.: US 2023/0094024 A1
(43) Pub. Date: Mar. 30, 2023

(54) RECHARGEABLE LITHIUM BATTERY

(71) Applicant: SAMSUNG SDI CO., LTD., Yongin-si (KR)

(72) Inventors: Hongryeol PARK, Yongin-si (KR); Myunghoon KIM, Yongin-si (KR); Sanghoon KIM, Yongin-si (KR); Yunhee KIM, Yongin-si (KR); Injun PARK, Yongin-si (KR); Jeongmin SHIN, Yongin-si (KR); Seungryong OH, Yongin-si (KR); Myunghwan JEONG, Yongin-si (KR); Hyunbong CHOI, Yongin-si (KR)

(21) Appl. No.: 17/893,027

(22) Filed: Aug. 22, 2022

(30) Foreign Application Priority Data
Aug. 26, 2021 (KR) 10-2021-0113347

(51) Int. Cl. H01M 10/0567; H01M 10/0525; H01M 4/36; H01M 4/525; H01M 4/587; H01M 4/62; H01M 4/131

(52) U.S. Cl. CPC H01M 10/0567; H01M 10/0525; H01M 4/364; H01M 4/525; H01M 4/587; H01M 4/625; H01M 4/131; H01M 2300/0028; H01M 2004/028

(57) ABSTRACT

A rechargeable lithium battery includes a positive electrode including a positive active material; a negative electrode including a negative active material; and an electrolyte including a non-aqueous organic solvent, a lithium salt, and an additive represented by Chemical Formula 1, wherein a volume of the rechargeable lithium battery is about 5 cm³ to about 200 cm³.

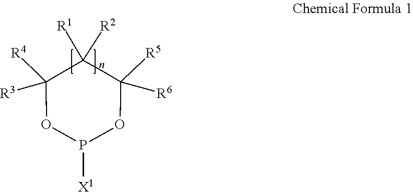

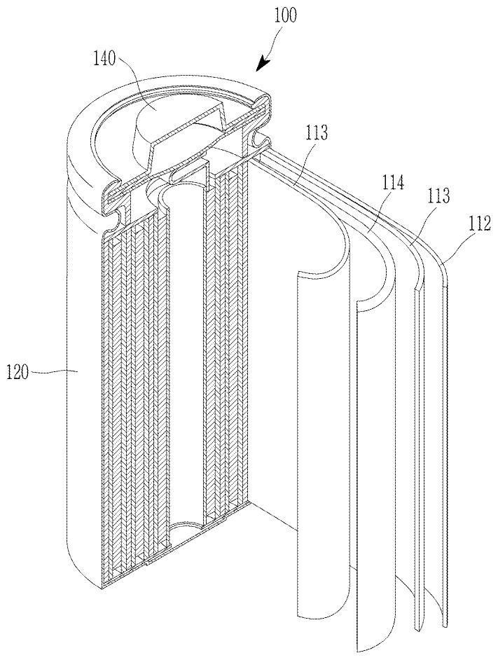

Details of Chemical Formula 1 are as described in the specification.

### CROSS-REFERENCE TO RELATED APPLICATION

This application claims priority to and the benefit of Korean Patent Application No. 10-2021-0113347, filed in the Korean Intellectual Property Office on Aug. 26, 2021, the entire content of which is incorporated herein by reference.

### BACKGROUND

### 1. Field

The present disclosure relates to a rechargeable lithium battery having improved high-temperature storage characteristics.

### 2. Description of the Related Art

A rechargeable lithium battery may be recharged and may have an energy density per unit weight as high as three or more times that of a related art lead storage (or lead acid) battery, nickel-cadmium battery, nickel hydrogen battery, nickel zinc battery and/or the like. It may also be charged at a high charging rate and thus, may be suitable (e.g., commercially manufactured) for a laptop, a cell phone, an electric tool, an electric bike, and/or the like. Researches, e.g., on improvement of energy density have been actively conducted.

For example, as information technology (IT) devices increasingly (e.g., continuously) achieve higher performance, a high-capacity battery is desired or required. While the high capacity may be realized through expansion of a voltage range, increasing the energy density may cause a problem of deteriorating performance of a positive electrode due to oxidization of an electrolyte solution in the high voltage range.

For example, LiPF₆, which is commonly (e.g., most often) utilized as a lithium salt of the electrolyte solution, may react with an electrolyte solvent to promote (or cause) depletion of the solvent and generate a large amount of gas. LiPF₆ may be decomposed and produce a decomposition product such as HF, PF₅, and/or the like, which may cause the electrolyte depletion and lead to performance deterioration and insufficient safety at a high temperature.

The decomposition products of the electrolyte solution may be deposited as a film on the surface of an electrode to increase internal resistance of the battery and eventually may cause problems of deteriorated battery performance and shortened cycle-life. In addition, this side reaction is further accelerated at a high temperature where the reaction rate becomes faster, and gas components generated due to the side reaction may cause a rapid increase of an internal pressure of the battery and thus may have a strong adverse effect on the stability of the battery.

Oxidization of the electrolyte solution is accelerated (e.g., greatly accelerated) in the high voltage range and thus is known to greatly increase the resistance of the electrode during the long-term charge and discharge process.

Accordingly, there is a need for an electrolyte suitable for usage under conditions of a high voltage and a high temperature.

### SUMMARY

Aspects according to one or more embodiments are directed toward a rechargeable lithium battery with improved battery stability (by suppressing decomposition of an electrolyte and a side reaction with an electrode) and simultaneously or concurrently, with improved initial resistance and high-temperature storage characteristics (by improving impregnation of the electrolyte in a positive electrode).

Additional aspects will be set forth in part in the description which follows and, in part, will be apparent from the description, or may be learned by practice of the presented embodiments of the disclosure.

According to an embodiment of the present disclosure, a rechargeable lithium battery includes a positive electrode including a positive active material; a negative electrode including a negative active material; and an electrolyte including a non-aqueous organic solvent, a lithium salt, and an additive represented by Chemical Formula 1, wherein a volume of the rechargeable lithium battery is about 5 cm³ to about 200 cm³.

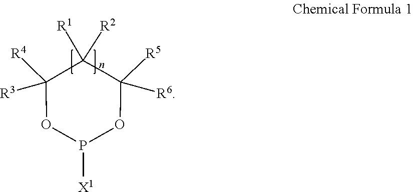

In Chemical Formula 1, X¹ is a fluoro group (—F), a chloro group (—Cl), a bromo group (—Br), or an iodo group (—I), R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and n is 0 or 1.

The rechargeable lithium battery according to the embodiments suppresses a decomposition of the electrolyte and side reaction with the electrode, thereby reducing gas generation and suppressing an increase in internal resistance of the battery at the same time. Therefore, the rechargeable lithium battery may have improved battery stability and high-temperature storage characteristics.

### BRIEF DESCRIPTION OF THE DRAWING

The drawing is a schematic view illustrating a rechargeable lithium battery according to an embodiment.

### DETAILED DESCRIPTION

Hereinafter, example embodiments will be described in more detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “a combination thereof” refers to a mixture, a laminate, a composite, a copolymer, an alloy, a blend, a reaction product, and/or the like of constituents.

Herein, it should be understood that terms such as “comprises,” “includes,” or “have” are intended to designate the presence of an embodied feature, number, step, element, or a combination thereof, but does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In addition, the term “layer” as used herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron micrograph or a scanning electron micrograph. Alternatively, it is possible to obtain an average particle diameter value by measuring utilizing a dynamic light scattering method, performing data analysis, counting the number of particles for each particle size range, and calculating from these data. Unless otherwise defined, the average particle diameter may refer to the diameter (D50) of particles having a cumulative volume of 50 volume % in the particle size distribution. For example, the average particle diameter may be, for example, a median diameter (D50) measured utilizing a laser diffraction particle diameter distribution meter. Also, as used herein, the singular forms “a”, “an” and “the” are intended to include the plural forms as well, unless the context clearly indicates otherwise.

As used herein, in the term “substituted or unsubstituted”, the term “substituted” refers to that a hydrogen atom in a compound is replaced by a substituent selected from a halogen atom (F, Br, Cl, and/or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C1 to C20 heteroalkyl group, a C2 to C20 heteroaryl group, a C3 to C20 heteroarylalkyl group, a C3 to C30 cycloalkyl group, a C3 to C15 cycloalkenyl group, a C6 to C15 cycloalkynyl group, a C2 to C30 heterocycloalkyl group, and a combination thereof. In some embodiments, the hydrogen atom in the compound may be replaced by a substituent selected from a halogen atom (F, Br, Cl, and/or I), a hydroxy group, an alkoxy group, a nitro group, a cyano group, an amino group, a C1 to C20 alkyl group, a C6 to C30 aryl group, a C1 to C30 alkoxy group, a C3 to C30 cycloalkyl group, and a combination thereof.

In the present disclosure, the term “or” is not to be construed as an exclusive meaning, and for example, “A or B” is construed to include A, B, A+B, and/or the like.

### Rechargeable Lithium Battery

The drawing is a schematic view illustrating a rechargeable lithium battery according to an embodiment. Referring to the drawing, a rechargeable lithium battery 100 according to an embodiment includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

A rechargeable lithium battery may be classified as a lithium ion battery, a lithium ion polymer battery, or a lithium polymer battery according to the presence of a separator and the type or kind of electrolyte utilized therein. The rechargeable lithium battery may have a variety of suitable shapes and sizes, and may be a cylindrical, prismatic, coin, or pouch-type or kind battery, and/or may be a thin film battery or be rather bulky in size. The rechargeable lithium battery according to an embodiment may be a coin-shaped or circular rechargeable lithium battery, but the present disclosure is not limited thereto.

The rechargeable lithium battery according to an embodiment has a volume of about 5 cm³ to about 200 cm³, which may be expressed (e.g., referred to) as a cell volume. The volume of the rechargeable lithium battery may refer to the internal volume of the battery case. That is, the volume of each battery is standardized, and in the present invention, the volume of the battery may mean the volume of the battery case itself standardized for each battery. In an embodiment, high-temperature storage characteristics may be improved (e.g., remarkably improved) by including the additive represented by Chemical Formula 1 in the electrolyte and at the same time (e.g., concurrently or simultaneously) adjusting the cell volume to a certain range (e.g., the above described range). The cell volume may be, for example, about 10 cm³ to about 180 cm³, or about 15 cm³ to about 150 cm³.

### Electrolyte

The electrolyte for a rechargeable lithium battery according to an embodiment includes a non-aqueous organic solvent, a lithium salt, and an additive represented by Chemical Formula 1.

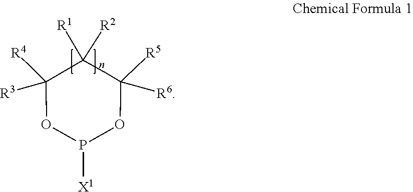

In Chemical Formula 1, X¹ is a fluoro group (—F), a chloro group (—Cl), a bromo group (—Br), or an iodo group (—I), R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and n is 0 or 1.

The additive represented by Chemical Formula 1 forms a solid electrolyte interface (SEI) film having suitable or high high-temperature stability and having suitable or excellent ion conductivity on the surface of the negative electrode, and suppresses a side reaction of LiPF₆ due to the functional group such as —PO₂F and thus reduces gas generation due to a decomposition reaction of the electrolyte when stored at a high temperature.

For example, the additive represented by Chemical Formula 1 may be coordinated with a pyrolyzed product of a lithium salt such as LiPF₆ or anions dissociated from the lithium salt and thus form a complex, and the complex formation may stabilize the pyrolyzed product of the lithium salt such as LiPF₆ or the anions dissociated from the lithium salt to suppress undesired side reaction of the anions with the electrolyte. Accordingly, the cycle-life characteristics of the rechargeable lithium battery may be improved, and gas generation inside the rechargeable lithium battery may be prevented or reduced, thereby reducing (e.g., remarkably reducing) a failure rate and improving high-temperature storage characteristics.

The additive represented by Chemical Formula 1 may be, for example, represented by Chemical Formula 1A or Chemical Formula 1B.

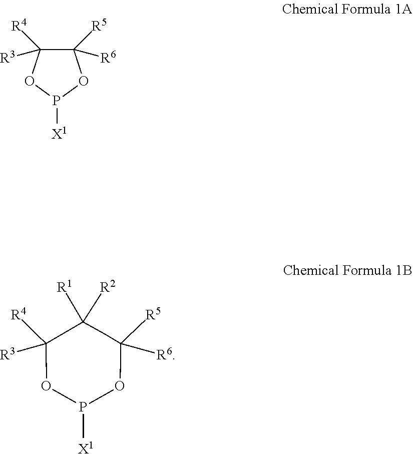

In Chemical Formula 1A and Chemical Formula 1B, X¹ is a fluoro group (—F) a chloro group (—Cl), a bromo group (—Br), or an iodo group (—I), and R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, in Chemical Formula 1A and Chemical Formula 1B, R¹, R², R³, and R⁴ may each be hydrogen, and R⁵ and/or R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, the additive represented by Chemical Formula 1 may be represented by Chemical Formula 1A. In Chemical Formula 1A, R³ and R⁴ may each be hydrogen, and R⁵ and/or R⁶ may be a substituted or unsubstituted C1 to C10 alkyl group. In an embodiment, R³, R⁴, R⁵, and R⁶ of Chemical Formula 1A may each be hydrogen.

For example, the additive represented by Chemical Formula 1 may be one of the compounds of Group 1, and may be, for example, 2-fluoro-1,3,2-dioxaphospholane and/or 2-fluoro-4-methyl-1,3,2-dioxaphospholane.

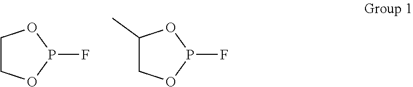

The additive represented by Chemical Formula 1 may be included in an amount of about 0.1 parts by weight to about 10.0 parts by weight, for example, about 0.1 parts by weight to about 9.0 parts by weight, about 0.1 parts by weight to about 7.0 parts by weight, about 0.1 parts by weight to about 5.0 parts by weight, about 0.1 parts by weight to about 3.0 parts by weight, or about 0.2 parts by weight to about 3.0 parts by weight based on 100 parts by weight of the total electrolyte excluding the additive (e.g., non-aqueous organic solvent+lithium salt=100 parts by weight).

The rechargeable lithium battery including the electrolyte may exhibit suitable or excellent high-temperature storage characteristics and/or cycle-life characteristics.

The non-aqueous organic solvent serves as a medium for transmitting ions taking part in the electrochemical reaction of a battery. The non-aqueous organic solvent may be a carbonate-based, ester-based, ether-based, ketone-based, alcohol-based, and/or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, y-butyrolactone, decanolide, valerolactone, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like, and the ketone-based solvent may include cyclohexanone, and/or the like. The alcohol-based solvent may include ethanol, isopropyl alcohol, and/or the like, and the aprotic solvent may include nitriles such as R—CN (wherein R is a hydrocarbon group having a C2 to C20 linear, branched, or cyclic structure and may include a double bond, an aromatic ring, or an ether bond), and/or the like, amides such as dimethyl formamide, and/or the like, dioxolanes such as 1,3-dioxolane, and/or the like, sulfolanes, and/or the like.

The non-aqueous organic solvent may be utilized alone or in a mixture, When the organic solvent is utilized in a mixture, the mixing ratio may be controlled in accordance with a desirable battery performance.

The carbonate-based solvent may be prepared by mixing a cyclic carbonate and a linear carbonate. When the cyclic carbonate and linear carbonate are mixed together in a volume ratio of about 1:1 to about 1:9, a performance of the electrolyte may be improved.

The non-aqueous organic solvent may further include an aromatic hydrocarbon-based organic solvent in addition to the carbonate-based solvent. In an embodiment, the carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound represented by Chemical Formula I.

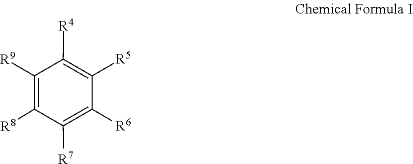

In Chemical Formula I, R⁴ to R⁹ are the same or different and are each independently hydrogen, a halogen, a C1 to C10 alkyl group, a C1 to C10 haloalkyl group, or a combination thereof.

Examples of the aromatic hydrocarbon-based organic solvent may include (e.g., may be) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinylene carbonate and/or an ethylene carbonate-based compound represented by Chemical Formula II in order to improve cycle-life of a battery.

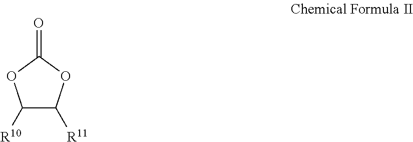

In Chemical Formula II, R¹⁰ and R¹¹ are the same or different, and are each independently hydrogen, a halogen, a cyano group, a nitro group, or a fluorinated C1 to C5 alkyl group, provided that R¹⁰ and/or R¹¹ is a halogen, a cyano group, a nitro group, or a fluorinated C1 to C5 alkyl group, and R¹⁰ and R¹¹ are not simultaneously hydrogen.

Examples of the ethylene carbonate-based compound may include (e.g., may be) difluoro ethylenecarbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive for improving cycle-life may be utilized within an appropriate range.

The electrolyte may further include one or more other additives in addition to those described above. The other additives may include, for example, vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), or a combination thereof. When the electrolyte further includes such other additives, high-temperature storage characteristics may be improved, and for example, gases generated from the positive electrode and the negative electrode during high-temperature storage may be effectively controlled.

The other additives may be included in an amount of about 0.2 parts by weight to about 20 parts by weight, for example, about 0.2 parts by weight to about 15 parts by weight, or about 0.2 parts by weight to about 10 parts by weight based on 100 parts by weight of the total electrolyte excluding the additive represented by Chemical Formula 1 and the one or more other additives (e.g., excluding additives (e.g., non-aqueous organic solvent+lithium salt=100 parts by weight)). In this case, an increase in the film resistance may be minimized or reduced to contribute to improvement of the battery performance.

The lithium salt dissolved in the non-organic solvent supplies lithium ions in a battery, enables a basic operation of the rechargeable lithium battery, and improves transportation of the lithium ions between positive and negative electrodes.

Examples of the lithium salt may include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(CyF_{2y+1}SO₂) (wherein, x and y are natural numbers, for example, an integer ranging from 1 to 20), lithium difluoro(bisoxalato) phosphate, LiCl, Lil, LiB(C₂O₄)₂ (lithium bis(oxalato) borate; LiBOB), and lithium difluoro(oxalato)borate (LiDFOB).

The lithium salt may be utilized in a concentration ranging from about 0.1 M to about 2.0 M. When the lithium salt is included at the above concentration range, the electrolyte may have suitable or excellent performance and lithium ion mobility due to optimal electrolyte conductivity and viscosity.

### Positive Electrode

A positive electrode for a rechargeable lithium battery may include a current collector and a positive active material layer disposed on the current collector. The positive active material layer may include a positive active material, and may further include a binder and/or a conductive material.

The positive active material may include lithiated intercalation compounds that reversibly intercalate and de-intercalate lithium ions. Examples of the positive active material may be a compound represented by one of chemical formulas:

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}Co_{b}X_{c}D_{α} (0.90≤a≤1.8, 0≤b≤0.5, 0.5≤c≤0.5, 0<α≤2);

LiₐNi_{1-b-c}Co_{b}X_{c}O_{2-α}T_{α} (0.90≤a≤1.8, 0≤b≤0.5, 0≤c≤0.05, 0<α≤2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤50.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂GbO₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2); and/or

LiₐFePO₄ (0.90≤a≤1.8).

In these chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface thereof, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer forming process may be any suitable method that does not adversely affect physical properties of the positive active material, for example, spray coating, dipping, and/or the like.

In an embodiment, a nickel-based positive active material may be applied as the positive active material. For example, the positive active material may be a high nickel-based positive active material in which a nickel content is greater than or equal to about 80 mol % based on the total amount of all elements excluding lithium and oxygen. In the high nickel-based positive active material, the nickel content may be greater than or equal to about 81 mol %, greater than or equal to about 86 mol %, greater than or equal to about 90 mol %, greater than or equal to about 91 mol %, or greater than or equal to about 93 mol % and less than or equal to about 99 mol %, or less than or equal to about 98 mol % based on the total amount of elements excluding lithium and oxygen. When the high nickel-based positive active material is utilized, suitable or very high capacity may be realized. The high nickel-based positive active material, in which a large amount of cations are mixed, has a problem of (e.g., rather significantly) deteriorated capacity and/or structurally destroyed active material, and generating a side reaction with an electrolyte. However, in one embodiment, the high nickel-based positive active material may be applied without these problems by adjusting a volume of the battery and simultaneously or concurrently including the additive represented by Chemical Formula 1 in the electrolyte. In addition, improved battery performance at a high temperature may be obtained according to embodiments of the present disclosure.

For example, the positive active material may include at least one lithium composite oxide represented by Chemical Formula 2.

LiₐNiₓCo_{y}M¹_{z}M²ₜO₂ Chemical Formula 2

In Chemical Formula 2, 0.9≤a<1.2, 0.8≤x<1.0, 0<y≤0.2, 0<z≤0.2, 0≤t≤0.1, x+y+z+t=1, M¹ is Mn, Al, or a combination thereof, and M² is B, Ba, Ca, Ce, Cr, Cu, F, Fe, Mg, Mo, Nb, P, S, Si, Sr, Ti, V, W, Zr, or a combination thereof.

In Chemical Formula 2, x may be, for example, 0.85≤x<1.0, 0.88≤x<1.0, 0.90≤x<1.0, 0.91≤x<1.0, 0.92≤x<1.0 or 0.93≤x<1.0.

The lithium composite oxide represented by Chemical Formula 2 may be, for example, represented by Chemical Formula 2-1 or Chemical Formula 2-2.

Liₐ₁ Niₓ₁CO_{y1}Al_{z1}M³_{(1-x1-y1-z1)}O₂ Chemical Formula 2-1

In Chemical Formula 2-1, 0.9≤a≤1.2, 0.80≤x1<1.0, 0<y1≤0.2, 0<z1≤0.20, and M³ is B, Ba, Ca, Ce, Cr, Cu, F, Fe, Mg, Mo, Nb, P, S, Si, Sr, Ti, V, W, Zr, or a combination thereof.

Liₐ₂Niₓ₂Co_{y2}Mn_{z2}M⁴_{(1-x2-y2-z2)}O₂ Chemical Formula 2-2

In Chemical Formula 2-2, 0.9≤a2≤1.2, 0.80≤x2<1.0, 0<y2≤0.20, 0<z2≤0.20, and M⁴ is B, Ba, Ca, Ce, Cr, Cu, F, Fe, Mg, Mo, Nb, P, S, Si, Sr, Ti, V, W, Zr, or a combination thereof.

The positive active material may be included in an amount of about 90 wt % to about 98 wt % based on the total weight of the positive active material layer.

The binder improves binding properties of positive active material particles with one another and with a current collector. Examples thereof may include (e.g., may be) polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The binder in the positive active material layer may be included in an amount of about 1 wt % to about 5 wt % based on the total weight of the positive active material layer.

The conductive material is included to provide electrode conductivity. Any suitable electrically conductive material may be utilized as a conductive material unless it causes a chemical change. Examples of the conductive material may include a carbon-based material such as natural graphite, artificial graphite, carbon black, acetylene black, ketjen black, a carbon fiber, a carbon nanotube, and/or the like; a metal-based material having a shape of a metal powder or a metal fiber including copper, nickel, aluminum, silver, and/or the like; a conductive polymer such as a polyphenylene derivative; or a mixture thereof.

The conductive material in the positive active material layer may be included in an amount of about 1 wt % to about 5 wt % based on the total weight of the positive active material layer.

According to an embodiment, the positive active material layer may include a carbon nanotube. By including the carbon nanotube, dispersibility of the positive active material slurry may be improved, processibility such as coating and/or the like may also be improved during formation of the positive active material layer, and/or conductivity of the positive active material layer may be improved. In addition, the effect of improving high-temperature storage characteristics according to the additive represented by Chemical Formula 1 in the electrolyte may be maximized or enhanced. The carbon nanotube may be included in an amount of about 0.1 wt % to about 3.0 wt %, about 0.5 wt % to about 3.0 wt %, or about 0.5 wt % to about 2.0 wt % based on the total weight of the positive active material layer. When the carbon nanotube in included in these ranges, the effect by the carbon nanotube may be increased to the maximum.

The positive electrode current collector may include an aluminum foil, but the present disclosure is not limited thereto.

### Negative Electrode

A negative electrode for a rechargeable lithium battery includes a current collector and a negative active material layer positioned on the current collector. The negative active material layer may include a negative active material, and may further include a binder and/or a conductive material.

The negative active material may include a material that is capable of reversibly intercalates/de-intercalates lithium ions, a lithium metal, a lithium metal alloy, a material capable of doping/de-doping lithium, and/a or transition metal oxide.

The material that is capable of reversibly intercalates/de-intercalates lithium ions may include a carbon-based negative active material, for example, crystalline carbon, amorphous carbon, or a combination thereof. The crystalline carbon may be irregularly shaped (e.g., non-shaped), or plate, flake, spherical, and/or fiber shaped natural graphite and/or artificial graphite. The amorphous carbon may be a soft carbon, a hard carbon, a mesophase pitch carbonization product, a calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/de-doping lithium may be a Si-based negative active material and/or a Sn-based negative active material. The Si-based negative active material may be silicon, a silicon-carbon composite, SiOₓ (0<x<2), a Si-Q alloy (wherein Q is an element selected from an alkali metal, an alkaline-earth metal, a Group 13 element, a Group 14 element excluding Si, a Group 15 element, a Group 16 element, a transition metal, a rare earth element, and a combination thereof), and the Sn-based negative active material may be Sn, SnO₂, a Sn—R alloy (wherein R is an element selected from an alkali metal, an alkaline-earth metal, a Group 13 element, a Group 14 element excluding Sn, a Group 15 element, a Group 16 element, a transition metal, a rare earth element, or a combination thereof), and/or the like. At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn (excluded for R), In, TI, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may include a coal-based pitch, mesophase pitch, a petroleum-based pitch, coal-based oil, petroleum-based heavy oil, and/or a polymer resin such as a phenolic resin, a furan resin, and/or a polyimide resin. A content of silicon may be about 10 wt % to about 50 wt % based on the total weight of the silicon-carbon composite. In addition, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In addition, a thickness of the amorphous carbon coating layer may be about 5 nm to about 100 nm. An average particle diameter (D50) of the silicon particles may be about 10 nm to about 20 pm. In an embodiment, the average particle diameter (D50) of the silicon particles may be desirably about 10 nm to about 200 nm. The silicon particles may be present in an oxidized form, and an atomic content ratio of Si:O in the silicon particles, indicating a degree of oxidation, may be about 99:1 to about 33:67. The silicon particles may be SiOₓ particles, and the range of x in SiOₓ may be greater than about 0 and less than about 2. In the present specification, as used herein, when a definition is not otherwise provided, an average particle diameter (D50) indicates a particle size where an accumulated volume is about 50 volume % in a cumulative particle-size distribution curve.

The Si-based negative active material and/or Sn-based negative active material may be mixed with the carbon-based negative active material. When the Si-based negative active material and/or Sn-based negative active material and carbon-based negative active material are mixed, a mixing ratio thereof may be about 1:99 to about 90:10 by weight ratio.

In an embodiment, the negative active material may include a material including about 70 wt % to about 99 wt % of the carbon-based active material and about 1 wt % to about 30 wt % of silicon-based active material. When the negative active material has the above described composition, basic battery performance such as cycle-life characteristics and/or the like may be maintained, while capacity is maximized or enhanced, and high-temperature storage characteristics may also be improved. Herein, the carbon-based active material may be crystalline carbon such as natural graphite, artificial graphite, and/or the like, and the silicon-based active material may be silicon nanoparticles, a silicon-carbon composite, or a combination thereof. In an embodiment, the negative active material may include, for example, about 90 wt % to about 99 wt % of the carbon-based active material and about 1 wt % to about 10 wt % of the silicon-based active material.

In the negative active material layer, the negative active material may be included in an amount of about 95 wt % to about 99 wt % based on the total weight of the negative active material layer.

In an embodiment, the negative active material layer may further include a binder, and may optionally further include a conductive material. A content of the binder in the negative active material layer may be about 1 wt % to about 5 wt % based on the total weight of the negative active material layer. In addition, when the conductive material is further included, the negative active material layer may include about 90 wt % to about 98 wt % of the negative active material, about 1 wt % to about 5 wt % of the binder, and about 1 wt % to about 5 wt % of the conductive material.

The binder improves binding properties of negative active material particles with one another and with a current collector. The binder includes a non-water-soluble binder, a water-soluble binder, or a combination thereof.

The non-water-soluble binder may be selected from polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, and a combination thereof.

The water-soluble binder may be a rubber-based binder and/or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluorine rubber, and a combination thereof. The polymer resin binder may be selected from polyethylene oxide, polyvinylpyrrolidone, polyepichlorohydrine, polyphosphazene, polyacrylonitrile, an ethylene propylene diene copolymer, polyvinylpyridine, chlorosulfonated polyethylene, a latex, a polyesterresin, an acrylic resin, a phenolic resin, an epoxy resin, polyvinyl alcohol, and a combination thereof.

When the water-soluble binder is utilized as a negative electrode binder, a thickener such as a cellulose-based compound may be further utilized to provide suitable viscosity. The cellulose-based compound includes one or more of carboxymethyl cellulose, hydroxypropylmethyl cellulose, methyl cellulose, and/or alkali metal salts thereof. The alkali metals may be Na, K, and/or Li. Such a thickener may be included in an amount of about 0.1 to about 3 parts by weight based on 100 parts by weight of the negative active material.

The conductive material is included to provide electrode conductivity. Any suitable electrically conductive material may be utilized as a conductive material unless it causes a chemical change. Examples of the conductive material may include a carbon-based material such as natural graphite, artificial graphite, carbon black, acetylene black, ketjen black, a carbon fiber, a carbon nanotube, and/or the like; a metal-based material having a shape of a metal powder and/or a metal fiber including copper, nickel, aluminum silver, and/or the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

### Separator

The separator 113 separates a positive electrode 114 and a negative electrode 112 and provides a transporting passage for lithium ions and may be any suitable generally-utilized separator in a lithium ion battery. That is, the separator 13 may have low resistance to ion transport and suitable or excellent impregnation for an electrolyte. The separator 113 may include, for example, a glass fiber, polyester, TEFLON (tetrafluoroethylene), polyethylene, polypropylene, polytetrafluoroethylene, or a combination thereof, and may have a form of a non-woven fabric or a woven fabric. For example, in a lithium ion battery, a polyolefin-based polymer separator such as polyethylene and/or polypropylene is mainly utilized. In order to ensure the heat resistance and/or mechanical strength, a coated separator including a ceramic component and/or a polymer material may be utilized. Optionally, it may have a mono-layered or multi-layered structure.

Structures and manufacturing methods for lithium ion batteries pertaining to this disclosure may be any suitable one in the related art.

The rechargeable lithium battery according to an embodiment has high capacity and has excellent storage stability, cycle-life characteristics, and high rate capability at high temperatures, and thus can be utilized in information technology (IT) mobile devices, electric vehicles, hybrid vehicles, and/or the like.

Hereinafter, examples of the present disclosure and comparative examples are described. It is to be understood, however, that the examples are for the purpose of illustration and are not to be construed as limiting the present disclosure.

### Example 1-1

### Manufacture of Positive Electrode

95 wt % of a LiNi_{0.94}Co_{0.04}Al_{0.02}O₂ positive active material, 3 wt % of a polyvinylidene fluoride binder, and 2 wt % of a carbon nanotube conductive material (average length: 50 pm) were mixed in an N-methyl pyrrolidone solvent, thereby preparing positive active material slurry. The positive active material slurry was coated on an aluminum current collector and then, dried and compressed, thereby manufacturing a positive electrode.

### Manufacture of Negative Electrode

98 wt % of a negative active material prepared by mixing 93.5 wt % of graphite and 6.5 wt % of a silicon-carbon composite, 1 wt % of a styrene-butadiene rubber binder, and 1 wt % of carboxylmethyl cellulose were mixed in distilled water, thereby preparing negative active material slurry. The negative active material slurry was coated on a copper current collector and then, dried and compressed, thereby manufacturing a negative electrode.

### Manufacture of Rechargeable Lithium Battery Cell

A rechargeable lithium battery cell was manufactured by disposing a 25 μm-thick polyethylene separator between the positive electrode and the negative electrode to manufacture an electrode assembly and then, injecting an electrolyte thereinto. The electrolyte was a composition prepared by adding a 1.5 M LiPF₆ lithium salt, 2.0 parts by weight of a 2-fluoro-4-methyl-1,3,2-dioxaphosphorane additive, 10 parts by weight of fluoroethylenecarbonate (FEC), and 0.5 parts by weight of succinonitrile (SN) in a solvent obtained by mixing ethylene carbonate, ethylmethyl carbonate, and dimethyl carbonate in a volume ratio of 2:1:7. Herein, the parts by weight refers to a relative content of additive(s) based on 100 parts by weight of the entire electrolyte excluding all additives (non-aqueous organic solvent+lithium salt=100 parts by weight). The manufactured battery cell was a circular cell with a volume of 17 cm³.

### Examples 1-1 to 4-6 and Comparative Examples 1-1 to 1-6

Each positive electrode, negative electrode, and rechargeable lithium battery cell were manufactured in substantially the same manner as Example 1 except that the volume of the battery cell was changed as shown in Table 1. Six samples of the same volume were prepared and evaluated, and these were expressed such as Examples 1-1, 1-2, 1-3, 1-4, 1-5 and 1-6.

### Evaluation Example 1: High-temperature Storage Characteristics

The battery cells according to the examples and the comparative examples were respectively constant current-charged to a voltage of 4.2 V at a current rate of 0.3 C at 25° C. and subsequently, cut off at a current rate of 0.05 C, while maintained at the 4.2 V in a constant voltage mode. Then, the cells were constant current-discharged to 2.5 V at a current rate of 0.2 C. After once more repeating the charge and discharge process, the cells were constant current-charged to a voltage of 4.2 V at a current rate of 0.3 C at 25° C. and then, cut off at a current of 0.05 C, while maintained at the 4.2 V in a constant voltage mode. The battery cells were stored at a high temperature of 60 OC for 60 days and then, measured with respect to a capacity retention rate (%), a resistance increase rate (%), and a gas internal pressure (MPa), and the results are shown in Table.

TABLE 1

| | | | 60° C. storage | 60° C. storage | 60° C. storage |
|---|---|---|---|---|---|
| | | Cell | capacity | resistance | gas internal |
| | | volume | retention rate @ | increase rate @ 60 | pressure @ 60 |
| | | (cm³) | 60 days (%) | days (%) | days (MPa) |
| Ex. | 1-1 | 17 | 84.5 | 61.7 | 0.68 |
| | 1-2 | | 84.4 | 58.3 | 0.57 |
| | 1-3 | | 87.4 | 55.4 | 0.55 |
| | 1-4 | | 86.7 | 52.1 | 0.52 |
| | 1-5 | | 83.8 | 51.5 | 0.53 |
| | 1-6 | | 80.3 | 58.9 | 0.58 |
| | 2-1 | 24 | 80.7 | 58.4 | 0.57 |
| | 2-2 | | 85.9 | 53.7 | 0.48 |
| | 2-3 | | 87.3 | 49.5 | 0.45 |
| | 2-4 | | 88.3 | 52.4 | 0.47 |
| | 2-5 | | 86.4 | 51.0 | 0.45 |
| | 2-6 | | 81.7 | 55.1 | 0.50 |
| | 3-1 | 84 | 79.1 | 56.5 | 0.52 |
| | 3-2 | | 80.2 | 53.1 | 0.44 |
| | 3-3 | | 81.5 | 50.9 | 0.42 |
| | 3-4 | | 84.3 | 51.1 | 0.43 |
| | 3-5 | | 82.2 | 53.2 | 0.48 |
| | 3-6 | | 81.9 | 56.8 | 0.48 |
| | 4-1 | 133 | 77.4 | 60.1 | 0.50 |
| | 4-2 | | 79.5 | 59.1 | 0.45 |
| | 4-3 | | 79.1 | 58.9 | 0.44 |
| | 4-4 | | 80.6 | 58.5 | 0.47 |
| | 4-5 | | 79.6 | 58.1 | 0.45 |
| | 4-6 | | 78.0 | 61.4 | 0.47 |
| Comp. Ex. | 1-1 | 296 | 75.2 | 62.3 | 0.47 |
| | 1-2 | | 77.9 | 61.0 | 0.39 |
| | 1-3 | | 77.6 | 59.9 | 0.41 |
| | 1-4 | | 78.0 | 60.4 | 0.38 |
| | 1-5 | | 76.8 | 60.2 | 0.42 |
| | 1-6 | | 76.0 | 61.2 | 0.44 |

Referring to Table 1, the cells each with a volume of 296 cm³ according to Comparative Examples 1-1 to 1-6 exhibited satisfactory gas internal pressure characteristics but a deteriorated capacity retention of less than or equal to 78% and a resistance increase rate of greater than 60% when stored at a high temperature of 60° C. and thus exhibited insufficient (e.g., greatly insufficient) high-temperature storage characteristics. On the contrary, the cells each with a volume of 17 to 133 cm³ according to the example embodiments exhibited an improved capacity retention rate and resistance increase rate during the storage at 60° C. and maintained satisfactory gas internal pressure characteristics and thereby, exhibited excellent high-temperature storage characteristics.

### Examples 5-1 to 8-4 and Comparative Examples 4-1 to 8-2

Battery cells were manufactured in substantially the same manner as Example 1 except that the content of the 2-fluoro-4-methyl-1,3,2-dioxaphosphorane additive and the cell volume were designed as shown in Table 2.

### Evaluation Example 2: High-temperature Storage Characteristics

The cells according to the examples and the comparative examples were constant current-charged to a voltage of 4.2 V at a current rate of 0.3 C at 25° C. and subsequently, cut off at a current rate of 0.05 C, while maintained at the 4.2 V in a constant voltage mode. The cells were constant current-discharged to 2.5 V at a current rate of 0.2 C. After once more repeating the charge and discharge process, the cells were constant current-charged to a voltage of 4.2 V at a current rate of 0.3 C at 25° C. and subsequently, cut off at a current rate of 0.05 C while maintained at the 4.2 V in a constant voltage mode. The battery cells were stored at a high temperature of 60° C. for 60 days and then, measured with respect to a capacity retention rate (%), a resistance increase rate (%), and a gas internal pressure (MPa), and the results are shown in Table 2 below.

TABLE 2

| | | | Content | 60° C. storage | 60° C. storage | 60° C. storage |
|---|---|---|---|---|---|---|
| | | Cell | of | capacity | resistance | gas internal |
| | | volume | additive | retention rate | increase rate | pressure @60 |
| | | (cm³) | (wt %) | @60 days (%) | @60 days (%) | days (MPa) |
| Comp. | 4-1 | 1 | 0.0 | 46.8 | 114.8 | 1.79 |
| Ex. | 4-2 | 17 | | 47.3 | 98.4 | 1.72 |
| | 4-3 | 24 | | 45.2 | 91.8 | 1.63 |
| | 4-4 | 84 | | 48.3 | 90.5 | 1.59 |
| | 4-5 | 133 | | 47.3 | 87.0 | 1.62 |
| | 4-6 | 296 | | 48.1 | 94.5 | 1.67 |
| Comp. Ex. | 5-1 | 1 | 1.0 | 84.2 | 50.7 | 0.71 |
| Ex. | 5-1 | 17 | | 89.3 | 44.8 | 0.48 |
| | 5-2 | 24 | | 87.2 | 42.8 | 0.53 |
| | 5-3 | 84 | | 88.6 | 40.4 | 0.58 |
| | 5-4 | 133 | | 89.1 | 40.8 | 0.44 |
| Comp. Ex. | 5-2 | 296 | | 79.1 | 39.9 | 0.60 |
| Comp. Ex. | 6-1 | 1 | 4.0 | 70.5 | 66.0 | 0.54 |
| Ex. | 6-1 | 17 | | 74.9 | 55.1 | 0.42 |
| | 6-2 | 24 | | 76.9 | 51.6 | 0.39 |
| | 6-3 | 84 | | 73.3 | 54.9 | 0.43 |
| | 6-4 | 133 | | 78.0 | 59.2 | 0.40 |
| Comp. Ex. | 6-2 | 296 | | 70.1 | 65.5 | 0.45 |
| Comp. Ex. | 7-1 | 1 | 8.0 | 62.7 | 75.4 | 0.45 |
| Ex. | 7-1 | 17 | | 66.4 | 68.5 | 0.33 |
| | 7-2 | 24 | | 70.5 | 70.4 | 0.32 |
| | 7-3 | 84 | | 64.4 | 71.2 | 0.37 |
| | 7-4 | 133 | | 65.1 | 69.0 | 0.35 |
| Comp. Ex. | 7-2 | 296 | | 63.4 | 72.6 | 0.38 |
| Comp. Ex. | 8-1 | 1 | 12.0 | 52.0 | 87.4 | 0.42 |
| Ex. | 8-1 | 17 | | 49.9 | 80.3 | 0.31 |
| | 8-2 | 24 | | 51.0 | 79.5 | 0.33 |
| | 8-3 | 84 | | 50.4 | 77.7 | 0.35 |
| | 8-4 | 133 | | 48.7 | 82.1 | 0.34 |
| Comp. Ex. | 8-2 | 296 | | 49.1 | 85.2 | 0.38 |

Referring to Table 2, the cells each utilizing an electrolyte to which the additive was not added according to Comparative Examples 4-1 to 4-6 exhibited capacity retention of less than or equal to 48.3% after stored at 60° C., a resistance increase rate of greater than or equal to 87%, and a gas internal pressure of greater than or equal to 1.59 MPa and thereby, exhibited insufficient (e.g., greatly insufficient) high-temperature storage characteristics. The cells each with a volume of 1 cm³ according to Comparative Examples 5-1, 6-1, 7-1, and 8-1 exhibited a relatively high resistance increase rate and a relatively high gas internal pressure after stored at 60° C. and thereby, exhibited insufficient high-temperature storage characteristics. The cells each with a volume of 296 cm³ according to Comparative Examples 5-2, 6-2, 7-2, and 8-2 exhibited a relatively low capacity retention rate and a relatively high resistance increase rate after stored at 60° C. and thereby, exhibited insufficient high-temperature storage characteristics.

On the contrary, the cells of Examples 5-1 to 5-4, 6-1 to 6-4, 7-1 to 7-4, and 8-1 to 8-4 all exhibited excellent high-temperature storage characteristics such as a capacity retention rate, a resistance increase rate, a gas internal pressure during the 60° C. storage, and/or the like. Accordingly, when the cell volume was adjusted to 5 cm³ to 200 cm³, together with the addition of a certain amount of the additive of Chemical Formula 1 to the electrolyte according to one embodiment, the high-temperature storage characteristics turned out to be remarkably improved.

As used herein, the term “and/or” includes any and all combinations of one or more of the associated listed items. Throughout the disclosure, the expression, such as “at least one of a, b or c”, “at least one selected from a, b, and c”, “at least one selected from the group consisting of a, b, and c”, etc., indicates only a, only b, only c, both (e.g., simultaneously) a and b, both (e.g., simultaneously) a and c, both (e.g., simultaneously) b and c, all of a, b, and c, or variation(s) thereof.

The use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims, and equivalents thereof.

### DESCRIPTION OF SYMBOLS

100: rechargeable lithium battery
112: negative electrode
113: separator
114: positive electrode
120: battery case
140: sealing member

What is claimed is:

1. A rechargeable lithium battery, comprising
a positive electrode comprising a positive active material;
a negative electrode comprising a negative active material; and
an electrolyte comprising a non-aqueous organic solvent, a lithium salt, and an additive represented by Chemical Formula 1;
wherein a volume of the rechargeable lithium battery is about 5 cm³ to about 200 cm³: 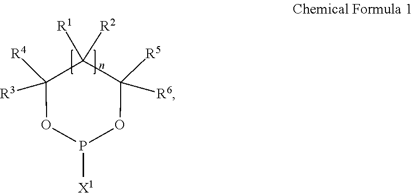
wherein, in Chemical Formula 1,
X¹ is a fluoro group (—F), a chloro group (—Cl), a bromo group (—Br), or an iodo group (—I),
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n is 0 or 1.

2. The rechargeable lithium battery of claim 1, wherein
the additive represented by Chemical Formula 1 is represented by Chemical Formula 1A or Chemical Formula 1B: 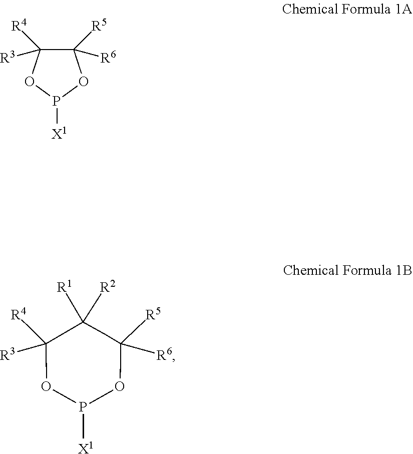
wherein, in Chemical Formula 1A and Chemical Formula 1B,
X¹ is a fluoro group (—F), a chloro group (—Cl), a bromo group (—Br), or an iodo group (—I), and
R¹ to R⁶ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

3. The rechargeable lithium battery of claim 2, wherein
in Chemical Formula 1A, R³ and R⁴ are each hydrogen, and R⁵ and/or R⁶ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The rechargeable lithium battery of claim 1, wherein
the additive represented by Chemical Formula 1 is at least one of compounds of Group 1:

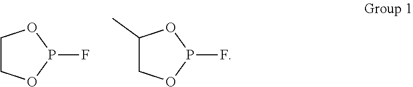

5. The rechargeable lithium battery of claim 1, wherein
the additive represented by Chemical Formula 1 is about 0.1 parts by weight to about 10 parts by weight in amount based on 100 parts by weight of the electrolyte excluding the additive.

6. The rechargeable lithium battery of claim 1, wherein
the electrolyte further comprises one or more other additives, and the one or more other additives comprise vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propenesultone (PST), propanesultone (PS), lithiumtetrafluoroborate (LiBF₄), lithium difluorophosphate (LiPO₂F₂), 2-fluoro biphenyl (2-FBP), or a combination thereof.

7. The rechargeable lithium battery of claim 6, wherein
the one or more other additives are about 0.2 parts by weight to about 20 parts by weight in amount based on 100 parts by weight of the electrolyte excluding the additive and the one or more other additives.

8. The rechargeable lithium battery of claim 1, wherein
the positive active material comprises at least one lithium composite oxide represented by Chemical Formula 2:
LiₐNiₓCo_{y}M¹_{z}M²ₜO₂ Chemical Formula 2
wherein, in Chemical Formula 2,
0.9≤a<1.2, 0.8≤x<1.0, 0<y≤0.2, 0<z≤0.2, 0≤t≤0.1, x+y+z+t=1,
M¹ is Mn, Al, or a combination thereof, and
M² is B, Ba, Ca, Ce, Cr, Cu, F, Fe, Mg, Mo, Nb, P, S, Si, Sr, Ti, V, W, Zr, or a combination thereof.

9. The rechargeable lithium battery of claim 8, wherein
in Chemical Formula 2, x is in a range of 0.90≤x<1.0.

10. The rechargeable lithium battery of claim 1, wherein
the positive electrode comprises a current collector and a positive active material layer on the current collector,
the positive active material layer comprises the positive active material and a carbon nanotube, and
the carbon nanotube is about 0.1 wt % to about 3.0 wt % in amount based on a total weight of the positive active material layer.

11. The rechargeable lithium battery of claim 1, wherein
the negative active material comprises about 70 wt % to about 99 wt % of a carbon-based active material and about 1 wt % to about 30 wt % of a silicon-based active material.

12. The rechargeable lithium battery of claim 11, wherein
the carbon-based active material is crystalline carbon and the silicon-based active material is a silicon nanoparticle, a silicon-carbon composite, or a combination thereof.
